(19) United States
(12) Patent Application Publication
(10) Pub. No.: US 2006/0107777 A1
(43) Pub. Date: May 25, 2006

(54) Leadscrew set for stepping motor

(75) Inventor: David Huang, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: Tricore Corporation, Chang Hua (TW)

(21) Appl. No.: 11/285,355

(22) Filed: Nov. 23, 2005

(30) Foreign Application Priority Data
Nov. 25, 2004 (TW) 93218983

(51) Int. Cl. F16H 27/02

(52) U.S. Cl. 74/89.23

(57) ABSTRACT

A leadscrew set is installed on a stepping motor which comprises a coil bobbin, the leadscrew set includes a leadscrew, which has a shaft body, a screw portion formed on periphery of the shaft body, a magnet connecting portion connected on an end of the shaft body, two gluing portions formed concave on the magnet connecting portion, each gluing portion has a gluing surface; a magnet part, which has a barrel body, a leadscrew fitting hole formed inside the barrel body and positioned at inward of the coil bobbin and the magnet connecting portion of the leadscrew; and a glue member, which glued between the gluing portions of the leadscrew and the leadscrew fitting hole of the magnet part.

### BACKGROUND OF THE INVENTION

1. Field of the Invention

The present invention relates to motors and more specifically, to a leadscrew set for stepping motor.

2. Description of the Related Art

A conventional leadscrew set for stepping motor, the leadscrew set comprises a magnet part which is difficult to assemble on a leadscrew, and the gluing effect cannot have a good connection between the magnet part and leadscrew. Moreover, there is not easy to make or waste more time and cost, and the structure of magnet part connected to the leadscrew causing poor magnetic effect, hence have to improvement.

### SUMMARY OF THE INVENTION

The present invention has been accomplished under the circumstances in view. It is therefore the main object of the present invention to provide a leadscrew set, which provided a better assembly between the leadscrew and magnet part, and the magnet part can be assembled on the leadscrew easily and firmly. It is another object of the present invention to provide a leadscrew set, which has better structure of the magnet part and layout relative to the leadscrew, providing good magnetic effect generated from the magnet part to the coil bobbin of the motor.

To achieve these and other objects of the present invention, the leadscrew set is installed on a stepping motor which comprises a coil bobbin, the leadscrew set comprises: a leadscrew, which has a shaft body, a screw portion formed on periphery of the shaft body, a magnet connecting portion connected on an end of the shaft body, two gluing portions formed concave on the magnet connecting portion, each gluing portion has a gluing surface; a magnet part, which has a barrel body, a leadscrew fitting hole formed inside the barrel body and positioned at inward of the coil bobbin and the magnet connecting portion of the leadscrew; and a glue member, which glued between the gluing portions of the leadscrew and the leadscrew fitting hole of the magnet part.

### BRIEF DESCRIPTION OF THE DRAWINGS

FIG. 1 is a sectional assembly view of the leadscrew set assembled on a stepping motor according to the present invention.

FIG. 2 is a sectional assembly view of the leadscrew set according to the present invention.

FIG. 3 is a sectional exploded view of the leadscrew set according to the present invention.

FIG. 4 is a sectional assembly view of the leadscrew set according to other embodiment of the present invention.

FIG. 5 is a sectional assembly view of the leadscrew set according to another embodiment of the present invention.

FIG. 6 is a sectional assembly view of the leadscrew set according to still other embodiment of the present invention.

FIG. 7 is a sectional assembly view of the leadscrew set according to still another embodiment of the present invention.

FIG. 8 is a schematic view of the leadscrew according to other embodiment of the present invention.

FIG. 9 is a schematic view of the leadscrew according to another embodiment of the present invention.

### DETAILED DESCRIPTION OF THE INVENTION

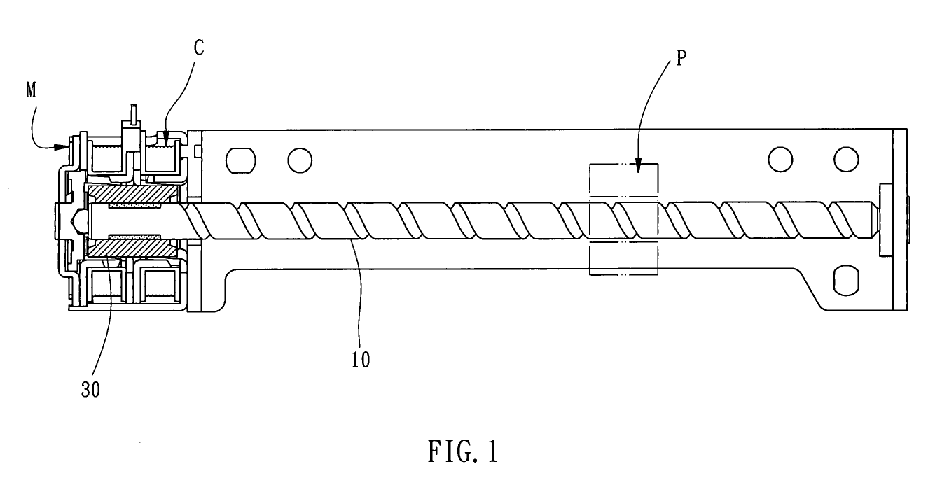

Referring to FIG. 1, a leadscrew set in accordance with the present invention adapted to assemble on a motor M which comprises a coil bobbin C, and provided for driving a movement set P moving forwards and backwards.

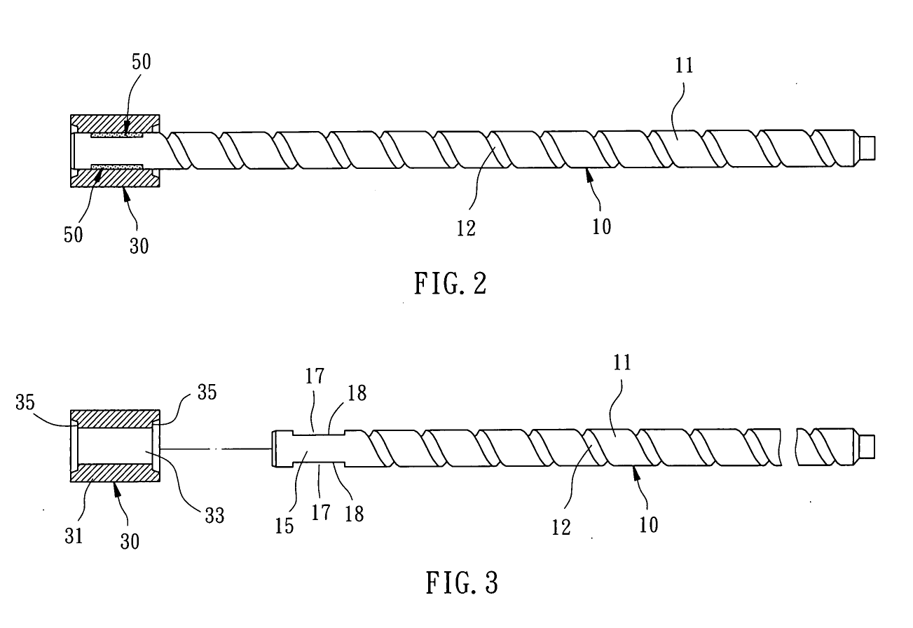

Referring to FIGS. 2 and 3, the leadscrew set comprises:

A leadscrew 10, which has a shaft body 11, a screw portion 12 formed on periphery of the shaft body 11, a magnet connecting portion 15 connected on an end of the shaft body 11, two gluing portions 17 formed of concave shape on the magnet connecting portion 15, each gluing portion 17 has a gluing surface 18.

A magnet part 30, which has a barrel body 31, a leadscrew fitting hole 33 formed inside the barrel body 31 and positioned at inward of the coil bobbin C and the magnet connecting portion 15 of the leadscrew 10, and two insert guiding holes 35 formed at the two each side opening of the leadscrew fitting hole 33.

A glue member 50, which glued between the gluing portions 17 of the leadscrew 10 and the leadscrew fitting hole 33 of the magnet part 30.

The operation status after assembled are described below:

Please refer FIG. 1 again, wherein the leadscrew 10 and the magnet part 30 are effected by conducting electric to the coil bobbin C, and the leadscrew 10 is driven to rotating by effect of the magnetic force generated by the coil bobbin C and the magnet part 30, therefore causing the movement set P moving by the rotation of the screw portion 12 of the leadscrew 10 relative to the direction of axial axis of the shaft body 11 of the leadscrew 10.

Because the magnet part 30 is firmly connected on the shaft body 11 and gluing portions 17 of the leadscrew 10 by the glue member 50, therefore the magnet part 30 still firmly connected on the leadscrew 10 and will not depart from the leadscrew 10 even on the status of high rotation speed of the leadscrew set.

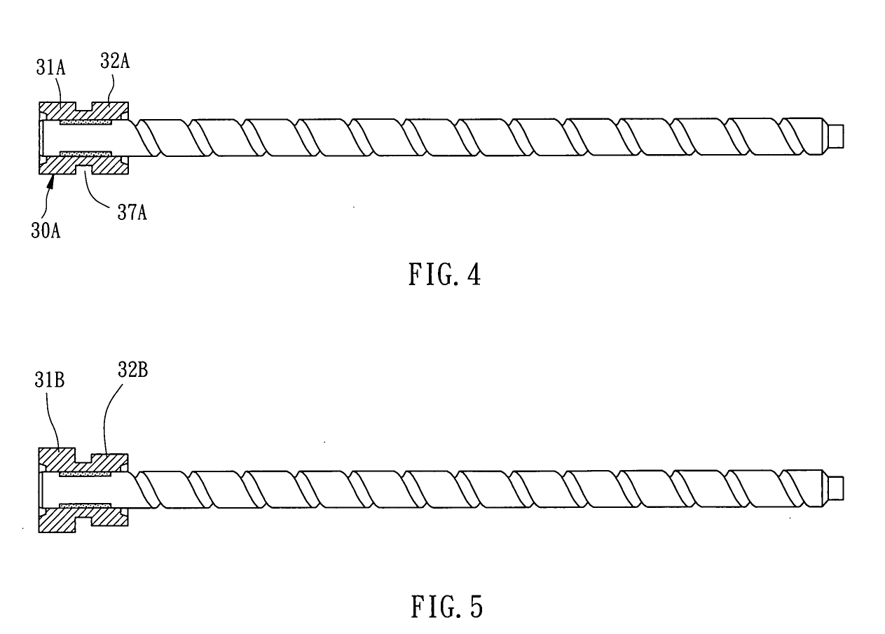

FIG. 4 is a sectional assembly view of the leadscrew set according to other embodiment of the present invention. According to this embodiment, the leadscrew is similar to aforesaid embodiment, the magnet part 30A has a circular groove 37A and forming two barrel bodies 31A and 32A, the barrel bodies 31A and 32A are located on the position relative to the inward of the coil bobbins respectively, hence generating more magnetic force and having the more rotation.

Further, the outer diameter of the two barrel bodies 31B and 32B are individual and different in aforesaid embodiment as shown in FIG. 5.

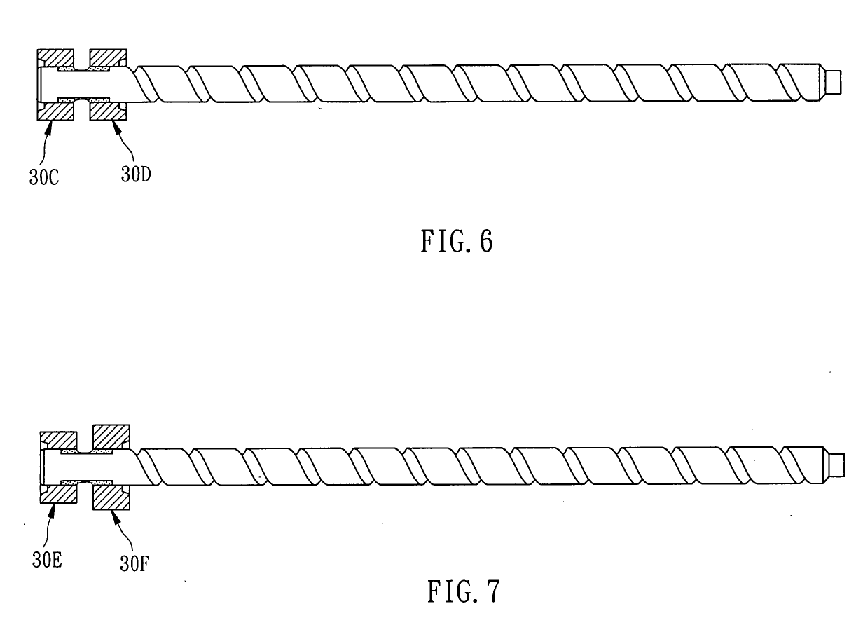

FIG. 6 is a sectional assembly view of the leadscrew set according to still other embodiment of the present invention. According to this embodiment, the leadscrew is similar to aforesaid embodiment, the leadscrew set comprises two magnet part 30C and 30D fitted and connected on the separated position of magnet connecting portion and gluing portion of the leadscrew; the magnet parts 30C and 30D are also located on the position relative to the inward of the coil bobbins respectively, hence generating more magnetic force and having the more rotation.

Further, the outer diameter of the two magnet parts 30E and 30F are different in aforesaid embodiment as shown in FIG. 7.

In aforesaid embodiments, the quality of the gluing portion of the leadscrew can be three or four or more, which still achieve the objects of the present invention.

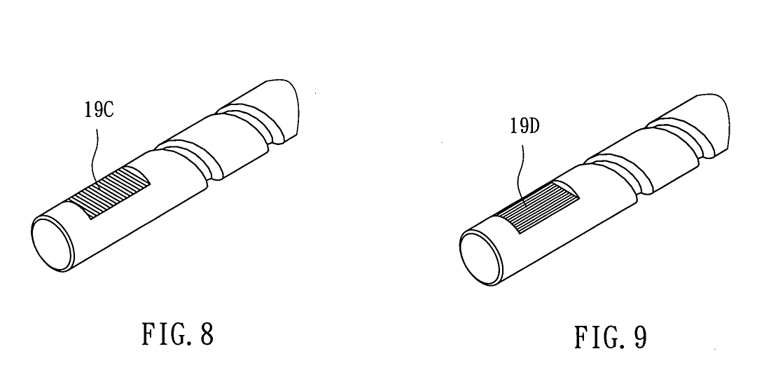

FIG. 8 is a schematic view of the leadscrew according to other embodiment of the present invention. According to this embodiment, the leadscrew further has a plurality of glue receiving gloves 19C formed on the gluing surface of the gluing portion of the leadscrew for more fixity between the magnet part and the leadscrew; or the glue receiving gloves 19D are disposed in the direction of the axial direction of the leadscrew as shown in FIG. 9; still the glue receiving gloves can be in any directions, and the shape of the glue receiving gloves are various.

As indicated above, the invention provides a leadscrew set for stepping motor, which has the following characteristics:

1. The leadscrew set provided a better assembly between the leadscrew and magnet part, and the magnet part can be assembled on the leadscrew easily and firmly.

2. The leadscrew set has better structure of the magnet part and layout relative to the leadscrew, providing good magnetic effect generated from the magnet part by the coil bobbin of the motor.

What is claimed is:

1. A leadscrew set adapted to assemble on a motor which comprising a coil bobbin, and provided for driving a movement set moving; the leadscrew set comprising:
a leadscrew, which has a shaft body, a screw portion formed on periphery of the shaft body, a magnet connecting portion connected on an end of the shaft body, two gluing portions formed concave on the magnet connecting portion, each gluing portion having a gluing surface;
a magnet part, which has a barrel body, a leadscrew fitting hole formed inside the barrel body and positioned at inward of the coil bobbin and the magnet connecting portion of the leadscrew; and
a glue member, which glued between the gluing portions of the leadscrew and the leadscrew fitting hole of the magnet part.

2. The leadscrew set as claimed in claim 1, wherein the quality of said gluing portion of the leadscrew is plurality or more.

3. The leadscrew set as claimed in claim 1, wherein the quality of said magnet part is plurality or more.

4. The leadscrew set as claimed in claim 3, wherein the outer diameter of said magnet parts are individual.

5. The leadscrew set as claimed in claim 1, wherein said magnet part further has an insert guiding hole formed at a side opening of the leadscrew fitting hole.

6. The leadscrew set as claimed in claim 1, wherein said magnet part has two barrel bodies formed integral with each other.

7. The leadscrew set as claimed in claim 1, wherein said gluing portion of said leadscrew further formed a plurality of glue receiving gloves thereon.

8. The leadscrew set as claimed in claim 7, wherein said glue receiving gloves of said leadscrew are layout at a direction by the axis of said leadscrew of transverse, parallel or slop.

9. A leadscrew set adapted to assemble on a motor which comprising a coil bobbin, and provided for driving a movement set moving; the leadscrew set comprising:
a leadscrew, which has a shaft body, a screw portion formed on periphery of the shaft body, a magnet connecting portion connected on an end of the shaft body;
a magnet part, which has a plurality of barrel bodies which located at an inward of said coil bobbin of said motor, a leadscrew fitting hole firmly fitted on said magnet connecting portion of the leadscrew.

10. The leadscrew set as claimed in claim 9, wherein the outer diameter of said barrel bodies of said magnet parts are individual.
